(19) United States
(12) Patent Application Publication
(10) Pub. No.: US 2009/0021760 A1
(43) Pub. Date: Jan. 22, 2009

(54) IMAGE SCANNING APPARATUS

(75) Inventors: Nobuhiko SUZUKI, Aichi (JP); Hiroko Ishikawa, Aichi (JP)

Correspondence Address: MCDERMOTT WILL & EMERY LLP, 600 13TH STREET, N.W., WASHINGTON, DC, 20005-3096, US

(73) Assignee: BROTHER KOGYO KABUSHIKI KAISHA

(21) Appl. No.: 12/175,080

(22) Filed: Jul. 17, 2008

(30) Foreign Application Priority Data
Jul. 20, 2007 (JP) 2007-189351

(51) Int. Cl. G06F 3/12; H04N 1/04

(52) U.S. Cl. 358/1.13; 358/475

(57) ABSTRACT

An image scanning apparatus is provided. The image scanning apparatus includes a reading unit including a light source and a light receiving element to receive light reflected to generate image data which corresponds to an image formed on an original document, a removable medium attachment unit, a removable medium detecting unit, which detects the removable medium being attached to the removable medium attachment unit, a writing unit to write the image data generated by the reading unit into the removable medium being attached to the removable medium attachment unit, a judging unit to judge as to whether the image scanning apparatus with the removable medium being attached is in a predetermined condition to read the image, and a switching unit to switch the light source on when the judging unit judges that the image scanning apparatus is in the predetermined condition.

### CROSS REFERENCE TO RELATED APPLICATION

This application claims priority from Japanese Patent Application No. 2007-189351, filed on Jul. 20, 2007, the entire subject matter of which is incorporated herein by reference.

### BACKGROUND

1. Technical Field

An aspect of the present invention relates to an image scanning apparatus capable of being driven by reduced power supply and having a lighting unit, which can be switched on in advance for a reading operation.

2. Related Art

Conventionally, a multifunction peripheral device having a reader unit to read an image formed on an original document and a printing unit to form an image on a recording sheet, is known. The plurality of functions of the multifunction peripheral device can be achieved in several switchable operational modes, such as a facsimile mode, a copier mode, and a scanner mode. In such a multifunction peripheral device, the reader unit is configured to have a light source to emit light onto an original document so that the light reflected on the original document is received by CCDs (charge-coupled devices), which are aligned in lines in a main scanning direction, and converted into voltage values according to intensities of the reflected light. The voltage values are further converted into digital data, which thus represents the image on the original document. A fluorescent lamp such as a cold-cathode tube lamp, which emits lights in a wider range, may preferably be used for the light source in the reader unit.

When a device having the reader unit as described above is designed and used, reduction of electric power consumption is considered to be significant. Specifically, the light source of the reader unit can consume a large amount of electric power; therefore, a total amount of electric power consumption can be largely reduced if the light is switched off when the reader unit is not in use and switched on when the reader unit is operated to scan the original document.

In consideration of the electronic power consumption in the reader unit, for example, a copier in which power supply to the reader unit is cut off when the copier is not in use while power supply to the reader unit thereof is switched on when the original document being placed in a reading position is detected, is disclosed in Japanese Patent Provisional Publication No. 2006-217075.

### SUMMARY

For the copier in the above-referenced publication, however, considerable time is required until the lamp, specifically the fluorescent lamp, is stabled to emit substantial amount of light for the reading operation. Therefore, according to the configuration of the reader unit in the above-referenced publication, in which the reader unit is powered on when the original document is placed therein, a user is required to wait for the considerable time period until the light amount is stabled. In the copier in the above-referenced publication, in addition, the lamp in the reader unit can be powered on each time the user operates a key of the copier regardless of the user's intention to operate the reader unit, and the electricity can be wasted.

In view of the above drawbacks, the present invention is advantageous in that an image scanning apparatus capable of being operated with reduced power supply is provided. Further, the image reading apparatus according to the present invention can switch the light source on when a preceding event, by which initiation of the reading operation can be predicted, occurs so that the user should be kept standing by for a shorter period of time until the reading operation starts.

According to an aspect of the present invention, an image scanning apparatus is provided. The image scanning apparatus includes a reading unit including a light source to emit light onto an original document and a light receiving element to receive the light reflected on the original document to generate image data which corresponds to an image formed on the original document, a removable medium attachment unit, to which a removable medium is attached, a removable medium detecting unit, which detects the removable medium being attached to the removable medium attachment unit, a writing unit to write the image data generated by the reading unit into the removable medium being attached to the removable medium attachment unit, a judging unit to judge as to whether the image scanning apparatus with the removable medium being attached is in a predetermined condition to read the image, and a switching unit to switch the light source on when the judging unit judges that the image scanning apparatus is in the predetermined condition.

According to the above configuration, the light source can be switched on when the removable medium attached to the image scanning apparatus is in the predetermined condition to read the image. Therefore, the light source can be prevented from being wastefully switched on when use of the reader unit is not expected, and can be effectively lighted and stabled in a shorter period of time for the user when the valid instruction, which can induce the reading operation of the reader unit, is entered. In addition, because the light source according to the present invention can be lighted less frequently, a lifetime of the light source can be prolonged effectively.

### BRIEF DESCRIPTION OF THE ACCOMPANYING DRAWINGS

FIG. 1 shows an overall perspective view of an MFP (multifunction peripheral) according to an embodiment of the present invention.

FIG. 2 illustrates an electric configuration of the MFP according to the embodiment of the present invention.

FIGS. 3A-3E illustrate screens to be displayed in the MFP according to the embodiment of the present invention.

FIG. 4 is a flowchart to illustrate a USB memory monitoring process to be performed in the MFP according to the embodiment of the present invention.

FIG. 5A illustrates a modified example of a criterion to judge in S7 of the USB memory monitoring process according to the embodiment of the present invention. FIG. 5B is a list to illustrate configuration to be stored in a criteria setting area according to the embodiment of the present invention.

### DETAILED DESCRIPTION

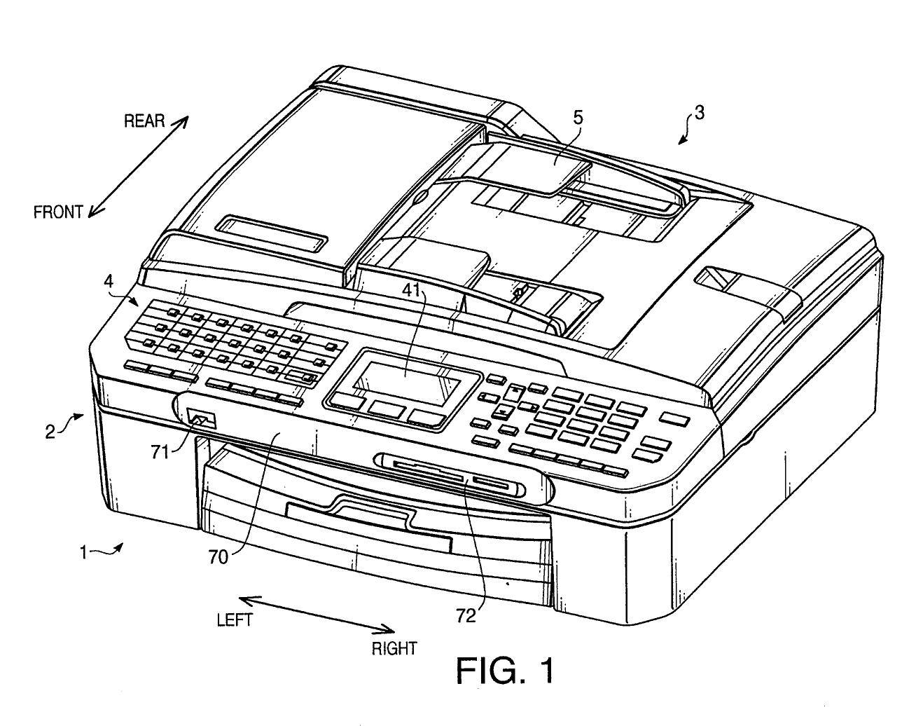

Hereinafter, an embodiment according to an aspect of the present invention will be described with reference to the accompanying drawings. FIG. 1 shows an overall perspective view of an MFP 1 according to an embodiment of the present invention. The MFP 1 includes a printer unit 2 in a lower portion, a scanner unit 3 in an upper portion, and an operation panel 4 on a top front portion, as shown in FIG. 1.

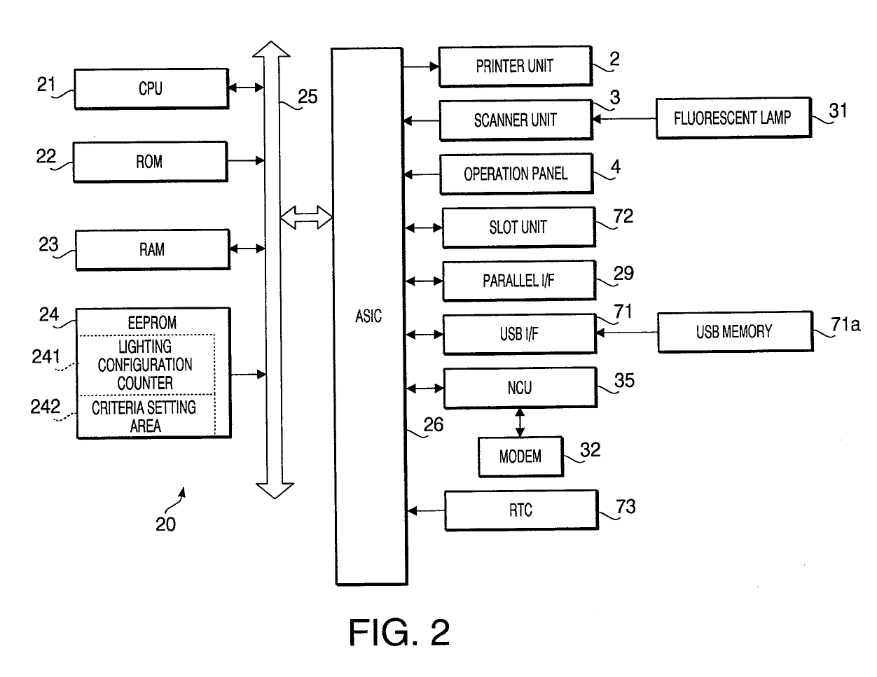

The scanner unit 3 includes a white fluorescent lamp 31 (FIG. 2) as a light source to emit light, which is reflected on an original document placed on a document platen (not shown). The reflection is received by an image capturing device (not shown) and converted into electric signals. Thus, image data representing an original image formed on the original document is generated based on the electric signals. The scanner unit 3 also includes an automatic sheet feeder 5, which feeds a plurality of sheets of original documents one by one onto the document platen so that the light from the light source is reflected on the original documents and the images formed on the original documents can be captured.

The MFP 1 is configured to be operated in one of a plurality of operational modes, which include a copier mode, a facsimile mode, and a scanner mode. In the copier mode, image data is generated through the scanner unit 3 according to an instruction from a user and is output to be printed on a recording sheet through the printer unit 2. In the facsimile mode, the image data is transmitted to an external receiver device (not shown) through a telephone line according to an instruction from the user. In the scanner mode, the image data is transmitted to an external device (not shown) such as a PC (personal computer) through a network or stored in a memory medium such as a memory card attached to the MFP 1 according to an instruction from the user. The MFP 1 can be also operated automatically in a printer mode, upon receipt of image data being transmitted from an external computer, in which the image data received in the MFP 1 is output to be printed on the recording sheet through the printer unit 2. A mode in which the MFP 1 is currently operated will be hereinafter referred to as a current operational mode. The MFP 1 according to the present embodiment is configured to be automatically switched from a current operational mode to the facsimile mode when a predetermined standby period has elapsed in the other operational modes.

The MFP 1 further includes a connector panel 70 adjacent to the operation panel 4. A USB I/F (interface) 71, into which a USB terminal of a USB cable (not shown) is inserted so that an external device (e.g., a USB memory 71a and a digital camera (not shown)) connected to the other end of the USB cable and the MFP 1 can be connected for communication, is arranged on a left hand side of the connector panel 70. Further, a slot unit 72 is arranged on a right hand side of the connector panel 70. The slot unit 72 includes a plurality of types of card slots, and each of a plurality of types of memory cards can be inserted into a corresponding card slot so that data can be exchanged between the memory card and the MFP 1. In the present embodiment, the MFP 1 can obtain image data from the memory card when the memory card is inserted in one of the card slots.

The operation panel 4 includes components to provide interface between the MFP 1 and a user so that the user can enter instructions to operate the MFP 1. Various operation keys 40 and an LCD (liquid crystal display) 41, which also serves as a touch panel, are included in the operation panel 4. The user can thus enter instructions for desired operations through the operation panel 4. When an instruction is entered through the operation panel 4, behaviors of the MFP 1 are controlled by a control unit 20 (FIG. 2) according to information corresponding to the instruction.

Next, an electrical configuration of the MFP 1 according to the embodiment of the present invention will be described with reference to FIG. 2. FIG. 2 illustrates the electrical configuration of the MFP 1 according to the embodiment of the present invention. The MFP 1 includes a parallel I/F 29, which provides connection between the MFP 1 and an external device such as an external PC (not shown) through a cable, the USB I/F 71, and the slot units 72. With these interfaces, the MFP 1 can be connected with external devices and external storage media such as a PC, a digital camera, and a removable medium. However, the connection between the MFP 1 and the external devices is not necessarily through these interfaces, but may be provided through a network I/F, which is not shown. The MFP 1 is further provided with an RTC (real time clock) 73.

The MFP 1 includes a control unit 20, which is a microcomputer, including a CPU (central processing unit) 21, a ROM (read only memory) 22, a RAM (random access memory) 23, and an EEPROM (electrically erasable and programmable ROM) 24. The control unit 20 is connected to an ASIC (application specific integrated circuit 26) through a bus 25.

The CPU controls the entire behaviors of the MFP 1. The ROM 22 is a memory medium to store various controlling programs to be executed by the CPU 21 and various information to be used in the programs. The ROM 22 includes an area to store a USB memory monitoring program, which will be described later in detail.

The RAM 23 is a rewritable memory medium, which can temporarily store various data to be used in the programs and serve as a work area for the programs. The EEPROM 24 is a rewritable nonvolatile memory medium, which includes a lighting configuration counter 241 and a criteria setting area 242, which will be described later in detail.

The ASIC 26 is connected with the control unit 20 through the bus 25. The ASIC 26 is further connected with the components of the MFP 1, which include the printer unit 2, the scanner unit 3, an operation panel 4, the LCD 41, the slot unit 72, the parallel I/F 29, the USB I/F 71, an NCU (network control unit) 35, and the RTC 73.

The NCU 35 is a unit to control facsimile communication to be performed with external devices through a telephone network and is connected with a modem 32.

The RTC 73 is a time-keeping IC (integrated circuit). The timing obtained by the CPU 21 from the RTC 73 is utilized in the operations in the MFP 1.

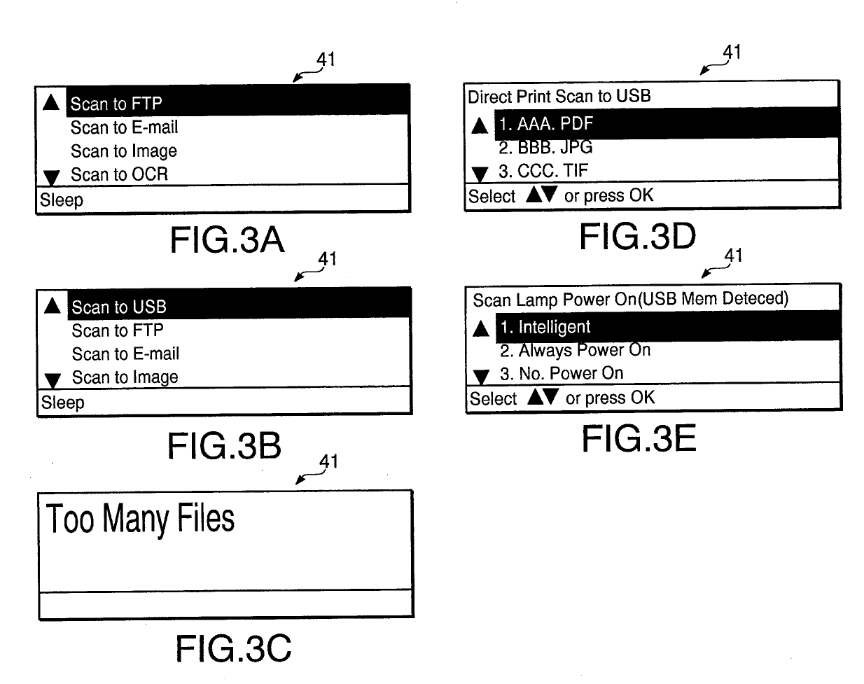

Next, exemplary operational statuses of the MFP 1 and screens to be displayed in the LCD 41 of the MFP 1 in the operational statuses will be described with reference to FIGS. 3A-3E. FIGS. 3A-3E illustrate the screens to be displayed in the LCD 41 of the MFP 1 according to the embodiment of the present invention.

FIG. 3A illustrates a screen to be displayed in the LCD 41 of the MFP 1 which is operated in the scanner mode and when the USB memory 71a is attached to the USB I/F 71. When the MFP 1 is operated in the scanner mode, selectable methods to output the scanned data (e.g., FTP transmission, E-mail transmission, generating image data, transmission to an OCR (optical character reader)) are presented in the LCD 41 so that the user can operate the operation keys 40 to enter a desired method.

FIG. 3B illustrates another screen to be displayed in the LCD 41 of the MFP 1 which is operated in the scanner mode and when the USB memory 71a is attached to the USB I/F 71. In the screen, an additional output method “Scan to USB,” which is not displayed in the screen shown in FIG. 3A, is presented. When the method “Scan to USB” is selected and a start key (not shown) on the operation panel 4 is operated, a scan-to-USB process, in which image data generated by the scanner unit 3 is passed to the USB memory 71a to be stored, is started.

FIG. 3C illustrates a screen to be displayed in the LCD 41 of the MFP 1 which is operated in the scanner mode with the USB memory 71a attached and when the USB memory 71a is incapable of accepting any additional data, as the storage area in the USB memory 71a is fully occupied. Thus, the user is notified of the status of the USB memory 71a being incapable of accepting additional data.

FIG. 3D illustrates a screen to be displayed in the LCD 41 of the MFP 1 with the USB memory 71a attached to the USB I/F 71 when a key (not shown) to start a direct-printing operation is operated. The direct-printing operation refers to an operation in which image data stored in the USB memory 71a is passed to the MFP 1 through the USB I/F 71 to be printed. In the screen, as shown in FIG. 3D, file names of the image data stored in the USB memory 71 and extensions to indicate types of the image data are shown. Thus, the user viewing the screen can operate the operation keys 40 to select the desired image data to be printed.

FIG. 3E illustrates a screen to be displayed in the LCD 41 of the MFP 1 when selectable options concerning a lighting configuration of the fluorescent lamp 31 are presented to the user. The screen is displayed when a menu key (not shown), which is operated when an initial configuration of the MFP 1 is to be viewed and optionally modified, is operated. The displayed options for the lighting configuration according to the present embodiment include “Intelligent,” “Always power on,” and “No power on.” Thus, the user viewing the screen can operate the operation keys 40 to select a desired lighting configuration. The entered selection is thereafter set in the lighting configuration counter 241 in the EEPROM 24.

The lighting configuration counter 241 in the EEPROM 24 is an area to store the configuration concerning lighting (switching on and off) the fluorescent lamp 31 in the scanner unit 3, and one of values 1, 2, and 3 indicating each optional setting is stored therein.

When the “intelligent” configuration is selected by the user, the value 1 is set in the lighting configuration counter 241. In the “intelligent” configuration according to the present embodiment, the fluorescent lamp 31 is switched on when the USB memory 71a newly attached to the USB I/F 70 is detected and when a predetermined criterion, which will be described later, is fulfilled.

When the “always power on” configuration is selected by the user, the value 2 is set in the lighting configuration counter 241. In the “always power on” configuration according to the present embodiment, the fluorescent lamp 31 is switched on when the USB memory 71a newly attached to the USB I/F 70 is detected regardless of the predetermined criterion. Therefore, the fluorescent lamp 31 can be switched on for warm-up upon attachment of the USB memory 71a to the USB I/F prior to the instruction for the scanning operation, and the scanned output can be provided to the user in a shorter waiting period.

When the “no power on” configuration is selected by the user, the value 3 is set in the lighting configuration counter 241. In the “no power on” configuration according to the present embodiment, the fluorescent lamp 31 is not switched on even when the USB memory 71a attached to the USB I/F 70 is detected. That is, the fluorescent lamp 31 is maintained switched off regardless of the attachment of the USB memory 71a; therefore, electricity to be consumed in the MFP 1 can be reduced.

A criterion for the lighting configuration as to whether the fluorescent lamp 31 should be switched on is defined in the criteria setting area 242. According to the present embodiment, when the “intelligent” configuration is selected, and the criterion defined in the criteria setting area 242 is fulfilled, it can be determined that the “scan-to-USB” process will likely to be executed, and the fluorescent lamp 31 is switched on to be warmed up in advance of the reading operation. It is to be noted that validity of criteria defined in the criteria setting area 242 can be modified according to the user's preference.

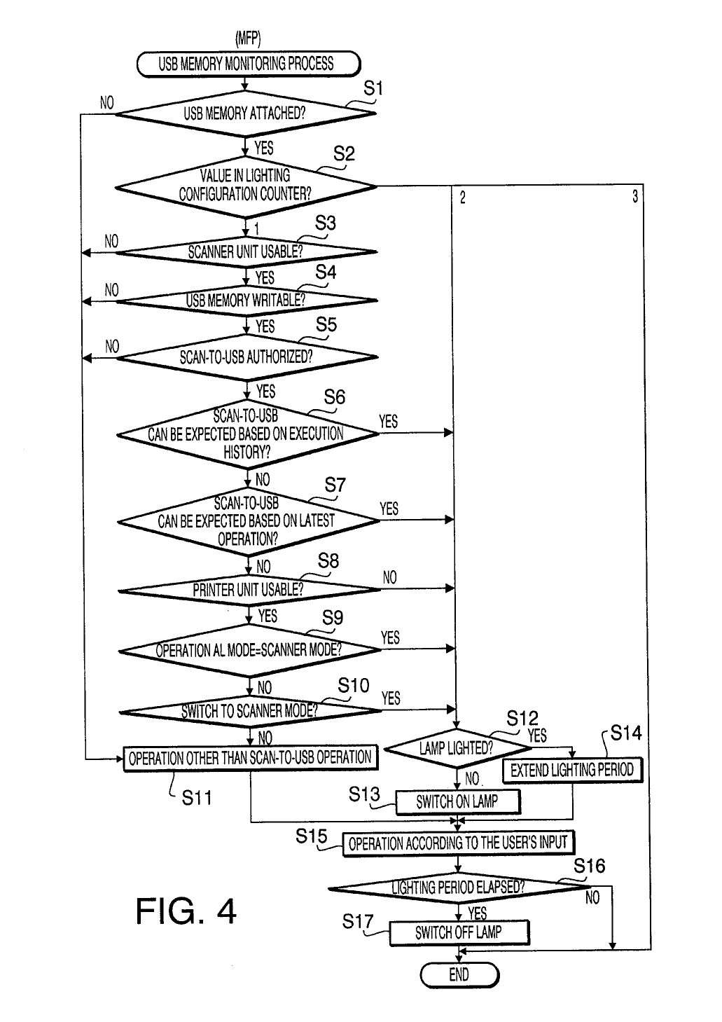

Next, a USB memory monitoring process to be executed in the MFP 1 according to the present embodiment will be described with reference to FIG. 4. FIG. 4 is a flowchart to illustrate the USB memory monitoring process according to the embodiment of the present invention. According to the present embodiment, the USB memory monitoring process is executed once the MFP 1 is powered on and at a predetermined interval. Further, all of the predetermined criteria are defined to be validated in the criteria setting area 242.

As the process starts, in S1, it is determined as to whether the USB memory 71a is attached to the USB I/F 71. If the USB memory 71a is attached (S1: YES), in S2, a value in the lighting configuration counter 241 is referred to.

If, for example, the value in the lighting configuration counter 241 is 1 (S2: 1), i.e., if the “intelligent” configuration is selected, the process proceeds to S3.

In S3, it is determined as to whether the scanner unit 3 is in a usable condition. More specifically, for example, when the scanner unit 3 is in use for scanning another document, when paper jam in the automatic sheet feeder 5 is detected, and when a data space in the MFP 1 for scanned image data is detected, it is determined that the scanner unit 3 is not in the usable condition.

If it is determined that the scanner unit 3 is in the usable condition, in S4, it is determined as to whether the storage area in the USB memory 71a attached to the USB I/F 71 is writable. More specifically, for example, when the USB memory 71a is protected from being written and incapable of accepting additional data, when the USB memory 71a is fully occupied, and when creating an additional file in the USB memory 71a is disabled due to a configuration of the file system, it is determined that the USB memory 71a is incapable of accepting additional data to be written (S4: NO).

If it is determined that the USB memory 71a is writable (S4: YES), in S5, it is determined as to whether the USB memory 71a is authorized based on accompanying identifying information stored in the USB memory 71a. It is to be noted in the MFP 1 according to the present embodiment that the USB memory 71a is required to be authorized in order for the scanned image data to be stored in the USB memory 71a in the scan-to-USB process for enhanced security. Optionally or additionally, the MFP 1 can be configured to provide the scan-to-USB function only to limited users, and a user who operates the MFP 1 to achieve the scan-to-USB function is required to be authorized. Therefore, in S5, if the USB memory 71a being attached is not authorized for the scan-to-USB process, and optionally or additionally, if the user is not authorized, negative judgment is made.

If negative judgment is made in any of S3 (S3: NO), S4 (S4: NO), and S5 (S5: NO), the process proceeds to S11, and the scan-to-USB function is not achieved. Therefore, the fluorescent lamp 31 is not switched on. In this configuration of the flow, the fluorescent lamp 31 is prevented from being switched on when the reading operation by the scanner unit 3 is not expected. Meanwhile, the fluorescent lamp 31 can be effectively switched on when the reading operation can be expected. Thus, the fluorescent lamp 31 can be prevented from being wastefully switched on, and an amount of electricity to be consumed in the MFP 1 can be reduced. It is to be noted that affirmative judgment in each of S3, S4, and S5 is a criterion for the fluorescent lamp 31 to be switched on.

Following S5, in S6, referring to execution history of direct-printing operations and scan-to-USB operations executed through the USB I/F 71, it is examined as to whether a scan-to-USB operation can be expected based on a predetermined criteria. More specifically, the history of operations executed in the attached USB memory 71a is referred to, and a criterion, as to whether a latest operation in the history is a scan-to-USB operation, is examined. If the latest operation executed in the attached USB memory 71a is a scan-to-USB operation, it can be expected that the user has attached the current USB memory 71a to the USB I/F 71 in order to obtain the image data to be stored in the USB memory 71a by the scan-to-USB operation again. Therefore, it is determined that the scan-to-USB operation can be currently expected (S6: YES).

Meanwhile, if the latest operation executed in the attached USB memory 71a is a direct-printing operation, it can be expected that the user has attached the current USB memory 71a to the USB I/F 71 in order to obtain a printed image on a recording medium by the direct-printing operation again. Therefore, it is determined that the scan-to-USB operation is not expected currently (S6: NO).

The execution history of the direct-printing operations and the scan-to-USB operations can be stored in any one of the USB memory 71a, any of the memory media in the MFP 1, and a storage unit in a network server (not shown) to which the MFP 1 is connected.

Optionally, the criterion to determine, as to whether the scan-to-USB operation can be expected, may not necessarily be the latest operation in the execution history. For example, frequency of the direct-print operations and frequency of the scan-to-USB operations found in the execution history can be compared, and the operations which have been executed more frequently can be examined in S6 to determine as to whether the scan-to-USB operation can be expected in the current operation. Further, a latest operation executed in the MFP 1 can be examined to determine the currently expected operation.

In S6, if it is determined that a scan-to-USB operation can be expected (S6: YES), in S12, it is determined as to whether the fluorescent lamp 31 is lighted. If the fluorescent lamp 31 is not lighted (S12: NO), in S13, the fluorescent lamp 31 is switched on. That is, power is supplied to the scanner unit 3. Optionally, after the fluorescent lamp 31 is switched on, a step to accelerate the warming-up and/or a step to judge as to whether the light amount is stabled can be added. With these steps, the scanning operation can be started speedily when an instruction to start the scanning operation is given.

In S12, if the fluorescent lamp 31 is lighted (S12: YES), in S14, a lighting period for the fluorescent lamp 31 is extended. In the present embodiment, the lighting period is a longer one of 30 minutes from the switching on of the fluorescent lamp 31 and 10 minutes from completion of a previous scanning operation. Therefore, the fluorescent lamp 31 can be automatically turned off after 30 minutes from the switching on of the fluorescent lamp 31 or 10 minutes from completion of a previous scanning operation; however, if it is determined that the fluorescent lamp 31 is lighted in S12, the light is maintained on for a predetermined additional period of time (e.g., 5 minutes). With this configuration, when the instruction to start the scanning operation is entered, the light of the fluorescent lamp 31 is maintained; therefore, the scanning operation can be started immediately.

In S6, if it is determined that the currently expected operation is not the scan-to-USB operation (S6: NO), in S7, data stored in the USB memory 71a is analyzed to judge as to whether a scan-to-USB operation can be expected in the current operation. More specifically, image data with a latest updated date among data files stored in the USB memory 71a is examined as to whether the latest operation to update the data was a scan-to-USB operation. If the latest operation was a scan-to-USB operation, it is determined that the currently expected operation is also a scan-to-USB operation (S7: YES). It is to be noted that an extension which indicates that the writing operation to the image data file is achieved by the scan-to-USB function may be provided to the data file, for example, in a header of the image data so that the judgment to examine as to whether the latest operation was the scan-to-USB operation can be easily made.

Optionally, the data files in the USB memory 71a can be examined to determine as to whether a data file usable for the direct-printing operation is included. When no data file usable for the direct-printing operation is included, it can be determined that a scan-to-USB operation is expected.

In S7, if it is determined that the currently expected operation is a scan-to-USB operation (S7: YES), in S12, it is determined as to whether the fluorescent lamp 31 is lighted. If the fluorescent lamp 31 is not lighted (S12: NO), in S13, the fluorescent lamp 31 is switched on.

In S7, if it is determined that the currently expected operation is not a scan-to-USB operation (S7: NO), in S8, it is determined as to whether the printer unit 2 is in a usable condition. More specifically, for example, when toner (or ink) is insufficient, and when a recording sheet is not provided, it is determined that the printer unit 2 is not in the usable condition. Additionally, when the printer unit 2 is in user for printing image data other than the current image data, it is determined that the printer unit 2 is not in the usable condition (S8: NO).

In S8, if it is determined that the printer unit 2 is not in the usable condition (S8: NO), it is determined that the currently expected operation for the USB memory 71a can be the scan-to-USB operation. Therefore, in S12, it is determined as to whether the fluorescent lamp 31 is lighted. If the fluorescent lamp 31 is not lighted (S12: NO), in S13, the fluorescent lamp 31 is switched on.

In S8, it is determined that the printer unit 2 is in the usable condition (S8: YES), in S9, it is determined as to whether the current operational mode is the scanner mode. If it is determined that the current operational mode is the scanner mode (S9: YES), in S12, it is determined as to whether the fluorescent lamp 31 is lighted. If the fluorescent lamp 31 is not lighted (S12: NO), in S13, the fluorescent lamp 31 is switched on.

In S9, if it is determined that the current operational mode is not the scanner mode (S9: NO), in S10, it is determined as to whether an instruction to switch the operational modes from the current operational mode to the scanner mode is entered. A scan-to-USB operation can be expected when the instruction to switch the operational mode to the scanner mode is entered. It is to be noted that a scan-to-USB operation can be expected from the instruction to switch the current operational mode to the scanner mode. Therefore, in S10, if it is determined that an instruction to switch the operational modes from the current operational mode to the scanner mode is entered (S10: YES), and in S12, if the fluorescent lamp 31 is not lighted (S12: NO), in S13, the fluorescent lamp 31 is switched on.

In S10, if it is determined that an instruction to switch the operational modes from the current operational mode to the scanner mode is not entered (S10: NO), in S11, an operation other than the scan-to-USB operation is performed, and the process proceeds to S15.

If affirmative judgment is made in all of S3 (S3: YES), S4 (S4: YES), and S5 (S5: YES), and in any of S6 (S6: YES), S7 (S7: YES), S8 (S8: YES), S9 (S9: YES), and S10 (S10: YES), the scan-to-USB operation can be expected. Therefore, the process proceeds to S12, and the fluorescent lamp 31 is switched on when it is not lighted. Thus, the fluorescent lamp 31 can be effectively switched on when the reading operation can be expected. Further, the fluorescent lamp 31 can be prevented from being wastefully switched on, and an amount of electricity to be consumed in the MFP 1 can be reduced. It is to be noted that affirmative judgment in any of S6, S7, S8, S9, and S10 following S5 is a criterion for the fluorescent lamp 31 to be switched on.

In S1, if the USB memory 71a is not detected (S1: NO), and following any of S11, S13, and S14, the process proceeds to S15. In S15, an operation according to the user's input is performed. For example, if the instruction to switch the current operational mode to the scanner mode is entered in S10, in S15, the operational mode is switched to the scanner mode. For another example, if an instruction to switch the current operational mode to the copier mode is entered, the current operational mode is switched to the copier mode. If an instruction to switch the current operational mode to the facsimile mode is entered, the current operational mode is switched to the facsimile mode.

When the start key (not shown) on the operation panel 4 is operated, in S15, the image formed on the original document is read by the scanner unit 3 and the image data generated based on the read image is stored in the USB memory 71a (i.e., the scan-to-USB operation is performed.) It is to be noted that the fluorescent lamp 31 is lighted in S13 or has been lighted in S14 prior to the scan-to-USB operation in S15. Therefore, the scanned output can be provided to the user in a shorter waiting period.

Following S15, in S16, it is determined as to whether the lighting period has elapsed with reference to the RTC 73. If it is determined that the lighting period has elapsed (S16: YES), in S17, the fluorescent lamp 31 is switched off. More specifically power supply to the scanner unit 3 is shut down. Meanwhile, in S16, if it is determined that the lighting period has not elapsed (S16: NO), the process skips S17 (i.e., the fluorescent lamp 31 is maintained lighted) and is terminated.

In S2, if the value in the lighting configuration counter 241 is 2 (S2: 2), i.e., if the “always power on” configuration is selected, the process proceeds to S12. That is, in the “always power on” configuration, the fluorescent lamp 31 is switched on upon attachment of the USB memory 71a to the USB I/F 71.

According to the MFP 1 in the above configuration, upon attachment of the USB memory 71a to the USB I/F 71, which induces the reading operation of the scanner unit 3, the fluorescent lamp 31 can be effectively lighted and stabled in a shorter period of time for the user.

Further, the lighting period is effectively extended when the fluorescent lamp 31 is already lighted and it is determined that the predetermined criteria are met. Therefore, the reading operation by the scanner unit 3 can be started in a shorter period of time for the user compared to a configuration in which the reading operation is started after the reading operation is confirmed.

Although an example of carrying out the invention has been described, those skilled in the art will appreciate that there are numerous variations and permutations of the image reading apparatus that falls within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

For example, in S7 in the USB memory monitoring process, judgment to determine as to whether the currently expected operation is a scan-to-USB operation may be made based on a count of the scan-to-USB operations performed with the current USB memory 71a, which is derived from analysis of the data files in the USB memory 71a.

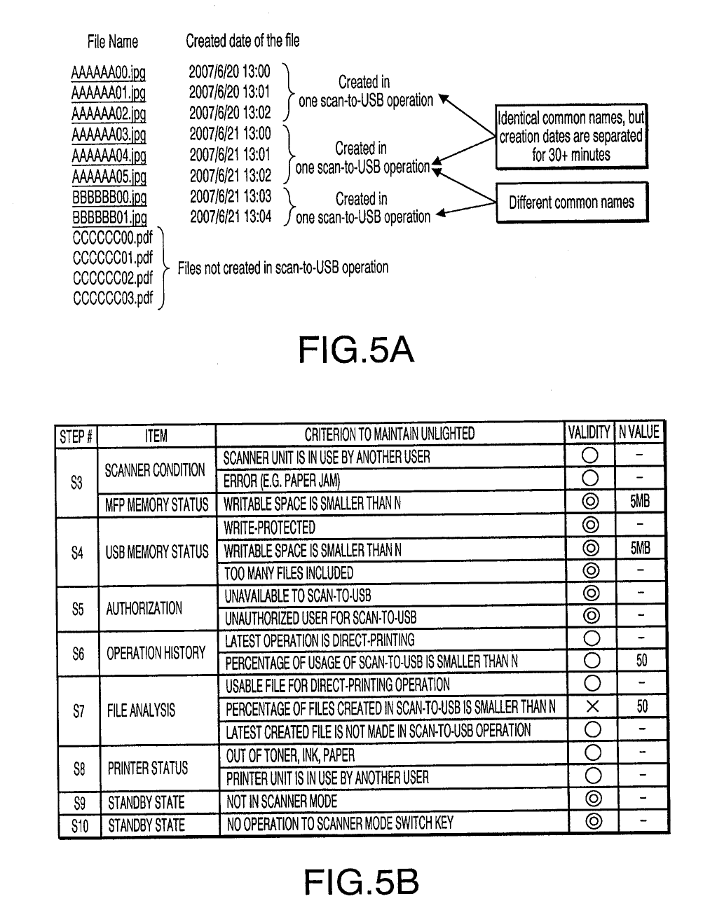

An exemplary method to analyze the data files to calculate the count of the scan-to-USB operations will be described hereinbelow with reference to FIG. 5A. FIG. 5A illustrates the method to calculate the number of scan-to-USB operations, which can be used in judgment in S7 of the USB memory monitoring process according to the embodiment of the present invention.

In the present example, image data files with file names as shown in FIG. 5A are stored in the USB memory 71a. Each of the file names has an extension (e.g., “.jpg” and “.pdf”); therefore, the image data files created in the scan-to-USB operations can be selectively recognized. In the present example, the image data files with extensions “.jpg” are determined to be the data files created in the scan-to-USB operations. Further, each of the file names is configured with a common name (e.g., “AAAAAA”, “BBBBBB”) and a serial number (e.g., “00”, “01”). According to the present example, the image data files having a same common name are considered to be the image data files which were created in one scan-to-USB operation regardless of a difference in the serial numbers. However, if created dates of the image data files having a same common name are separated from each other for more than a predetermined period (e.g., 30 minutes), the image data files are considered to be created in separated scan-to-USB operations even though the common names of the image data files are identical.

In the present example, a number of the image data files stored in the USB memory 71a having the extension “.jpg” is 8. Among these image data files, the image data files “AAAAAA00.jpg”-“AAAAAA02.jpg” are considered to be created in one scan-to-USB operation. Further, the image data files “AAAAAA03.jpg”-“AAAAAA05.jpg” are considered to be created in one scan-to-USB operation. Meanwhile, created dates of “AAAAAA02.jpg” and “AAAAAA03.jpg”-“AAAAAA05.jpg” are separated for more than 30 minutes; therefore, these image data files “AAAAAA02.jpg” and “AAAAAA03.jpg”-“AAAAAA05.jpg” are considered to be created in separate scan-to-USB operations. Similarly, the image data files “BBBBBB00.jpg”-“BBBBBB01.jpg” are considered to be created in one scan-to-USB operation. Thus, the number of the scan-to-USB operations performed for the image data files stored in the USB memory 71a is counted to be 3.

Further, in the present example, 4 image data files, which were not created in scan-to-USB operations, are stored in the USB memory 71a (i.e., “CCCCCC00.pdf”-“CCCCCC03.pdf”). Based on these numbers, a percentage of the number of scan-to-USB operations over the entire numbers of the image data files can be calculated (i.e., 3/7*100=43%). When the percentage of the number of scan-to-USB operations is over a predetermined ratio (e.g., 50%), the scan-to-USB operation can be expected for the current operation. Therefore, affirmative judgment is made in S7.

For another example, the MFP 1 according to the above embodiment is configured to be automatically switched to the facsimile mode when a predetermined standby period in the other operational modes has elapsed. However, the operational modes of the MFP 1 can be switched to the copier mode or to the scanner mode. It is to be noted that S9 in the USB memory monitoring process can be omitted when the operational modes are configured to be switched from the current operational mode to the scanner mode. In other words, the MFP 1 can be configured such that the fluorescent lamp 31 is not switched on when the USB memory 71a is attached to the MFP 1 in the scanner mode.

For another example, the memory medium to be attached to the MFP 1 for the storage of the image data files may not necessarily be the USB memory 71a, but may be a different type of memory medium such as an SD card, which can be inserted into a slot in the slot unit 72.

Further, in the USB memory monitoring process, each step to make judgment may contain a plurality of criteria, and the judgment in the step may be made totally based on the criteria. Further, validity and invalidity of each criterion defined in the criteria setting area 242 may be arbitrarily determined by the user.

FIG. 5B illustrates the settings of the criteria defined in the criteria setting area 242 according to the embodiment of the present invention. In FIG. 5B, a step number in the USB memory monitoring process is indicated in association with each criterion. In a “validity” column in FIG. 5B, a criterion, which is validated at all time, i.e., not configurable for a user, is indicated by a double circle. Meanwhile, a currently validated criterion is indicated by a single circle, and an invalidated criterion is indicated by an X. With the criteria setting area 242, in which some criteria can be validated and invalidated according to the user's preference so that the fluorescent lamp 31 can be switched on under specific conditions defined by the user. Further, a threshold N to be examined in each criterion can be arbitrarily determined by the user.

For example, according to the configuration shown in FIG. 5B, concerning S7, a criteria “a percentage of the image data files created in scan-to-USB operations is smaller than N %” is indicated by an X, i.e., invalidated. Therefore, the criterion is not referred to in order to make judgment in S7.

When one item includes more than one criterion, some of the criteria may be validated at all time and some may be validated by the user. In such a case, it can be configured such that the fluorescent lamp 31 is avoided from being switched on when at least one of the criteria is met. Alternatively, it can be configured such that the fluorescent lamp 31 is avoided from being switched on exclusively when all of the criteria are met.

In the criteria setting area 242 shown in FIG. 5B, the plurality of criteria in one item are listed in a prioritized order. Therefore, a criterion listed in an upper line is examined prior to a criterion listed in a lower line. Thus, the judgment can be effectively made according to the predetermined prioritized criteria. The prioritized order can be arbitrarily modified by the user.

In the above embodiment, the MFP 1 is described as an example to achieve the function of the image scanning apparatus of the present invention. However, the present application may be applied to an image scanning apparatus having a reader unit with a light source.

For example, the light source of the scanner unit 3 may not be necessarily the fluorescent lamp, but may be a different type of light such as a halogen lamp. The present invention can be specifically effective to a scanner unit having a light source which requires considerable time for warming-up from power-on.

In the above embodiment, the scanner unit 3 is a flatbed type scanner having the automatic sheet feeder 5; however, the present invention can be applied to an MFP having another type of scanners such as a handy-type scanner.

In the above embodiment, switching on and off the fluorescent lamp 31 is controlled by supplying and shutting down power to the entire scanner unit 3; however, the switching on and off the light source can be independently controlled regardless of the power state of the scanner unit 3.

What is claimed is:

1. An image scanning apparatus, comprising:
reading unit including a light source to emit light onto an original document and a light receiving element to receive the light reflected on the original document to generate image data which corresponds to an image formed on the original document;
removable medium attachment unit, to which a removable medium is attached;
removable medium detecting unit, which detects the removable medium being attached to the removable medium attachment unit;
writing unit to write the image data generated by the reading unit into the removable medium being attached to the removable medium attachment unit;
judging unit to judge as to whether the image scanning apparatus with the removable medium being attached is in a predetermined condition to read the image; and
switching unit to switch the light source on when the judging unit judges that the image scanning apparatus is in the predetermined condition.

2. The image scanning apparatus according to claim 1,
wherein the judging unit includes a reading condition judging unit, which judges as to whether the reading unit is in a predetermined condition to read the image to generate the image data; and
wherein the switching unit switches the light source on when the reading condition judging unit judges that the reading unit is in the predetermined condition to read the image.

3. The image scanning apparatus according to claim 1,
wherein the judging unit includes a writable condition judging unit, which judges as to whether the removable medium is in a predetermined writable condition to accept and store the image data generated by the reading unit; and
wherein the switching unit switches the light source on when the writable condition judging unit judges that the removable medium is in the predetermined writable condition.

4. The image scanning apparatus according to claim 1,
wherein the judging unit includes an authorization judging unit, which judges as to whether the removable medium is in a predetermined authorized condition to accept and store the image data generated by the reading unit; and
wherein the switching unit switches the light source on when the authorization judging unit judges that the removable medium is in the predetermined authorized condition.

5. The image scanning apparatus according to claim 1,
wherein the judging unit includes a user authorization judging unit, which judges as to whether a user of the removable medium is in a predetermined authorized condition to use the removable medium attached to the removable medium attachment unit; and
wherein the switching unit switches the light source on when the user authorization judging unit judges that the user of the removable medium is in the predetermined authorized condition.

6. The image scanning apparatus according to claim 1, further comprising:
data output unit to output data stored in the removable medium being attached to the removable medium attachment unit;
wherein the judging unit includes a writing operation judging unit, which judges as to whether a writing operation to write the image data into the removable medium by the writing unit is expected for a forthcoming operation in the image scanning apparatus based on past operations performed by the data output unit and the writing unit in cooperation with the removable medium; and
wherein the switching unit switches the light source on when the writing operation judging unit judges that the writing operation is expected for the forthcoming operation.

7. The image scanning apparatus according to claim 1,
wherein the judging unit includes an analyzing unit, which analyzes the data stored in the removable medium to judge as to whether a writing operation to write the image data into the removable medium by the writing unit is expected for a forthcoming operation in the image scanning apparatus; and
wherein the switching unit switches the light source on when the analyzing unit judges that the writing operation is expected for the forthcoming operation.

8. The image scanning apparatus according to claim 7,
wherein the analyzing unit analyzes the data stored in the removable medium to judge as to whether a latest operation performed in cooperation with the removable medium is the writing operation.

9. The image scanning apparatus according to claim 1, further comprising:
data output unit to output data stored in the removable medium being attached to the removable medium attachment unit,
wherein the judging unit includes an output condition judging unit, which judges as to whether the data output unit is in a predetermined operable condition to output the data in the removable medium; and
wherein the switching unit switches the light source on when the output condition judging unit judges that the data output unit is in an inoperable condition to output the data in the removable medium.

10. The image scanning apparatus according to claim 1,
wherein the image scanning apparatus is provided with a plurality of operational functions and capable of being operated in one of a plurality of switchable operational modes, which correspond to the operational functions respectively;
wherein the judging unit includes a mode judging unit, which judges as to whether a current operational mode of the image scanning apparatus is a scanning mode, in which the image data generated by the reading unit can be one of stored in the removable medium; and
wherein the switching unit switches the light source on when the mode judging unit judges that the current operational mode of the image scanning apparatus is the scanning mode.

11. The image scanning apparatus according to claim 10,
wherein the judging unit includes a switch operation judging unit, which judges as to whether an operation to switch the operational modes from a current operational mode being one of the operational modes other than the scanning mode to the scanning mode is entered in the image scanning apparatus; and
wherein the switching unit switches the light source on when the switch operation judging unit judges that the operation to switch the current operational mode to the scanning mode is entered.

12. The image scanning apparatus according to claim 1, comprising
a criteria setting unit to define criteria for the predetermined condition of the image scanning apparatus to be judged by the judging unit,
wherein the switching unit switches the light source on according to the judgment made by the judging unit based on the criteria defined by the criteria setting unit.

13. The image scanning apparatus according to claim 1, comprising:
light control unit to switch off the light source when a predetermined lighting period, in which the light source is maintained lighted, elapses; and
light judging unit to judge as to whether the light source is currently lighted,
wherein the light control unit is inactivated when the removable medium detecting unit detects that the removable medium attached to the removable medium attachment unit and the light judging unit judges that the light source is currently lighted so that the predetermined lighting is extended.

14. The image scanning apparatus according to claim 1, comprising:
light control unit to switch off the light source when a predetermined lighting period, in which the light source is maintained lighted, elapses; and
light judging unit to judge as to whether the light source is currently lighted,
wherein the light control unit is inactivated so that the predetermined lighting period is extended when the predetermined condition of the image scanning apparatus to switch the light source on is met.
